(19) United States
(12) Patent Application Publication
(10) Pub. No.: US 2016/0245002 A1
(43) Pub. Date: Aug. 25, 2016

(54) Locking post with an adjustable lock rod

(71) Applicant: Julian Michael Svenson, Cornwall (CA)

(72) Inventor: Julian Michael Svenson, Cornwall (CA)

(21) Appl. No.: 14/544,832

(22) Filed: Feb. 24, 2015

(51) Int. Cl. E05C 9/00; E05C 17/62; E05C 17/04; E05C 1/10

(52) U.S. Cl. CPC E05C 9/008; E05C 1/10; E05C 17/62; E05C 17/04; E05C 9/006

(57) ABSTRACT

A locking post for a closure having a locking unit in the middle of the post. The locking unit carries a latch movable transversely of the post between locked and unlocked positions. A bottom lock rod unit is slidably mounted in the bottom part of the post. The lock rod unit has a moving block, a lock rod extending from the bottom end of the moving block, and a rigid strap extending from the top end of the moving block to the locking unit and past the latch. The lock rod unit is movable within the post to move the lock rod from an unlocked position within the post out of the bottom end of the post to a locked position and to move the strap down past the latch. The latch on the locking unit is movable transversely of the post to a locked position in the path of movement of the strap to prevent the strap from returning to is unlocked position. An adjustable connection connects the strap to its moving block in a manner to be able to adjust the length of the lock rod unit.

### FIELD OF THE INVENTION

This invention relates to a locking post in a folding closure, the post having at least one adjustable lock rod.

### BACKGROUND ART

A folding closure may have one section unfolded from one side of an opening to close the opening or two sections, one on each side of the opening, unfolded from each side to close the opening. The free end of each section has a leading locking post that locks the section in the unfolded, closed position. One manner of locking the post in the closed position is to provide a lock rod within the bottom of the post that can be moved out from the bottom end of the post to enter an opening in the floor under the opening. Usually a second lock rod is also provided within the top of the post that can be moved out from the top end of the post to enter an opening in the top of the opening.

The closure sections are usually suspended by trolleys from an overhead rail in the opening and have a slight clearance from the ground when moved between open and closed positions. The lock rods usually extend a predetermined length from the end of the locking post on the closures sections when in the locking position. The extended length is normally sufficient to insert the rod deep enough into the opening in the floor that it cannot be removed by lifting the post up.

When installing the closure it is often found that the floor and/or the ceiling in the opening is not level. The area where the lock post is located when the closure section is open may, for example, be lower than the surrounding floor. The difference may result in the lock rod not entering the opening sufficiently to securely lock the section.

To overcome the problem of uneven floors, it has been known to threadably mount the lock rod in a lock rod unit in the bottom of the post and use an adjustment nut to adjust the distance the rod extends from the end of the post. The nut is fixed in position but can be rotated in either direction to raise or lower the rod, threaded through the nut. Thus the distance the lock rod extends from the end of the post can adjusted. An example of this adjustment arrangement is shown in U.S. Pat. No. 4,944,169 to Robert Labelle. It is difficult however to rotate the adjustment nut to adjust the distance the rod extends from the end of the post because of space limitations. In accordance with the present invention a lock rod unit is provided, the length of which can be adjusted without having to adjust the lock rod. The present invention further provides guide means for the lock rod unit making it easier to install and to operate.

### SUMMARY OF THE INVENTION

In one aspect, the present invention is directed toward a locking post for a folding closure having a locking unit fixed within the post. The locking unit carries a latch slidable across the post between an unlocked position and a locked position. A bottom lock rod unit is slidable in the lower part of the post between an unlocked position within the post and a locked position where the unit projects from the bottom end of the post to lock the post. The lock rod unit, in its unlocked position, extends up past the latch with the latch in its unlocked position. A handle outside the post is connected to the lock rod unit. The handle is used to move the lock rod unit down to its locked position allowing the latch to move to its locked position to retain the lock rod unit in its locked position.

In a further aspect, the lock rod unit has a moving block slidable within the post, a lock rod extending down from the bottom of the block and a rigid strap extending up from the top of the block. An adjustable connection connects the strap to the block to allow the length of the lock rod unit to be adjusted.

### BRIEF DESCRIPTION OF THE FIGURES IN THE DRAWINGS

FIG. 1 is a front elevation view of a folding closure;

FIG. 2 is schematic side view of the locking post with a side wall removed;

FIG. 3 is a cross-section view of the post taken along line 3-3 in FIG. 2 but with side wall installed;

FIG. 4, on the same sheet as FIG. 1, is a schematic view of the post in the area of the locking unit with a side wall of the post removed and a side wall of the lock unit removed, the lock unit unlocked;

FIG. 5, on the same sheet as FIG. 1, is a schematic view similar to FIG. 4 but with the lock unit locked;

FIG. 6, on the same sheet as FIG. 2, is a cross-section view of the post taken along line 6-6 in FIG. 2;

FIG. 7, on the same sheet as FIG. 2, is a cross-section view of the post taken along line 7-7 in FIG. 2;

FIG. 8, on the same sheet as FIG. 2, is detail view of the outside of a bottom portion of the post;

FIG. 9, on the same sheet as FIG. 3, is a detail, exploded, perspective view of one upper corner of the bottom moving block in the post and the bottom of the strap; and

FIG. 10, on the same sheet as FIG. 3, is a partial cross-section view of the one upper corner of the bottom moving block.

### DESCRIPTION OF THE INVENTION

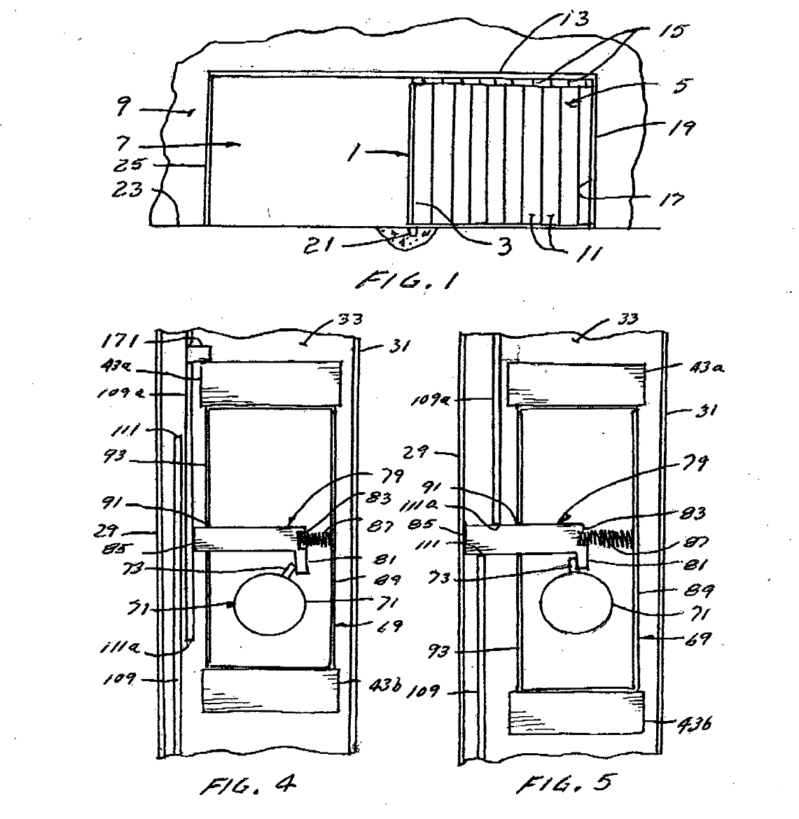

As shown in FIG. 1, the locking post 1 is used on the leading end 3 of a folding closure section 5 which is used to close part of an opening 7 in a wall 9. The folding closure section 5 comprises a plurality of panels 11 hingedly connected together and each suspended from a rail 13 at the top of the opening 7 by a trolley 15 connected to the top of each panel 11 and to the post 1. The other end 17 of the closure section 5 is fastened to one side 19 of the opening 7. The locking post 1, when unfolded, is located over a hole 21 in the floor 23 and a lock rod in the post, as will be described, is moved down from the post into the hole 21 to lock the unfolded closure section 5 in place under the rail 13. A second similar closure section (not shown) extends from the other side 25 of the opening 7 to lock to the one closure section 5 when it is locked in place on the floor.

The locking post 1, as shown in FIGS. 2 to 4, has front and rear walls 29, 31 joined by side walls 33, 35. The side walls 33, 35, as shown in FIG. 3, each have an interior wall section 36, 37 respectively at one side 38, 39 respectively, the wall sections 36, 37 extending toward each other. The wall sections 36, 37 pass adjacent a short wall 40, 41 respectively at one end 42 of each of a plurality of spaced-apart spacers 43. The short walls 40, 41 extend away from each other. The wall sections 36, 37 are attached to the short walls 40, 41 respectively of each of the spacers 43 used in the post by screws 44, one screw for each wall section 36, 37 for each spacer 43. The side walls 33, 35 are each detachably connected, near their other side 45 to the other end 47 of the spacers 43 with a first structural connection 49 between each spacer 43 and the side walls 33, 35. The spacers 43 are spaced apart and sandwiched between the side walls 33, 35 when assembly of the side walls 33, 35 to the spacers 43 is completed.

One side 51 of the front wall 29 is detachably connected to the interior wall section 36 on one side 38 of the one side wall 33 with screws 53 spaced apart along the length of the post. The other side 55 of the front wall 29 is detachably connected to the interior wall section 37 on one side 39 of side wall 35 with a second structural connection 57 along the length of the post. The front wall 29 covers the screws 44 joining the side walls 33, 35 to the spacers 43. The rear wall 31 is joined along one side 59 to the other side 45 of the side wall 33 by screws 61 spaced apart along the length of the post. A third structural connection 63 connects the other side 65 of the rear wall 31 to the other side 45 of side wall 35 for the length of the post. The screws 53, 61 are on the same side of the post 1 which is the inside of the post when the post is in operation. The inside of the post is the side facing the area closed by the closure 5.

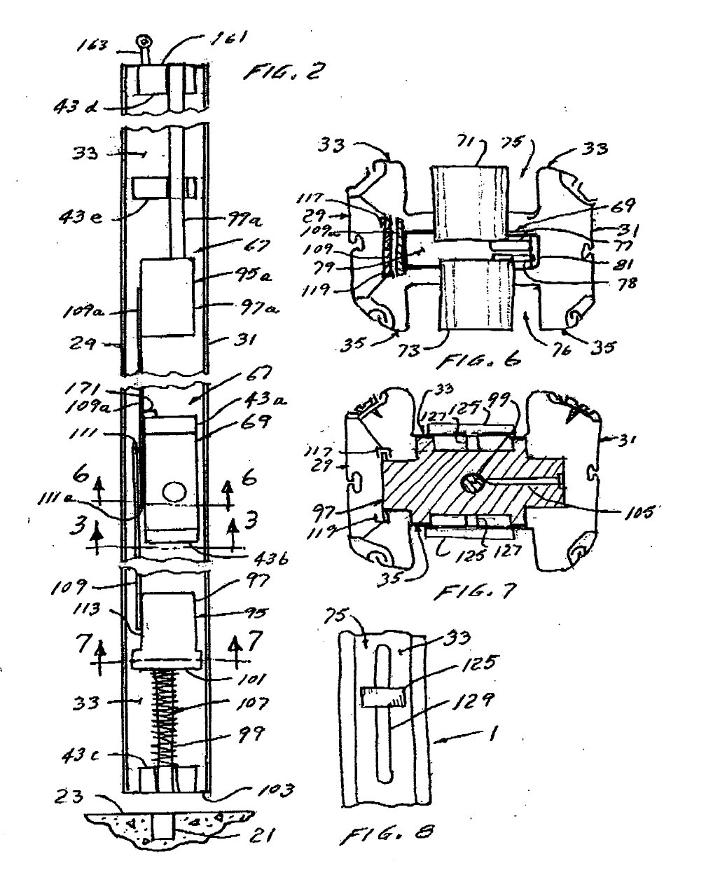

A lock structure 67, as shown in FIGS. 2 and 4-6 is mounted within the post 1. The lock structure 67 has a locking unit 69 mounted about midway along the length of the post between the side walls 33, 35. The locking unit 69 can be fastened to two of the spacers 43, spacers 43a, 43b, one at each end of the locking unit 69 as shown in FIGS. 2 and 4. A first cylinder lock 71 projects from the locking unit 69 through one side wall 33 of the post and a second cylinder lock 73 projects from the locking unit 69 through the other side wall 35 of the post. Preferably, the side walls 33, 35 are formed with central channels 75, 76, extending the length of the side walls and the cylinder locks 71, 73 are mounted within the channels as shown in FIG. 6. Each cylinder lock 71, 73 has a projecting cam member 77, 78 within the locking unit 69 that is rotatable. The locking unit 69 could be used with only a single cylinder lock if desired, or even with some other locking mechanism other than a cylinder lock for moving a latch 79 carried by the locking unit 69.

The latch 79 extends transversely to the locking post 1 in the locking unit 69 as shown in FIGS. 4-5. The latch 79 has a laterally extending tab 81 at its inner end 83 in the locking unit 69 parallel with the rear wall 31 of the post 1 and an outer end 85 facing the front wall 29 of the post. There is a compression spring 87 between the inner wall 89 of the locking unit 69 and the inner end 83 of the latch 79 to bias the latch out from the locking unit 69 through an opening 91 in the outer wall 93 of the locking unit 69 to a locked position. The latch 79 can be pushed by the spring 87 to the front wall 29 of the post to the locked position as shown in FIG. 5. Operation of either cylinder lock 71, 73 causes its respective cam member 77, 78 to rotate to engage the tab 81 on the latch 79 and to move the latch at least substantially back into the locking unit 69 to an unlocked position as shown in FIG. 4.

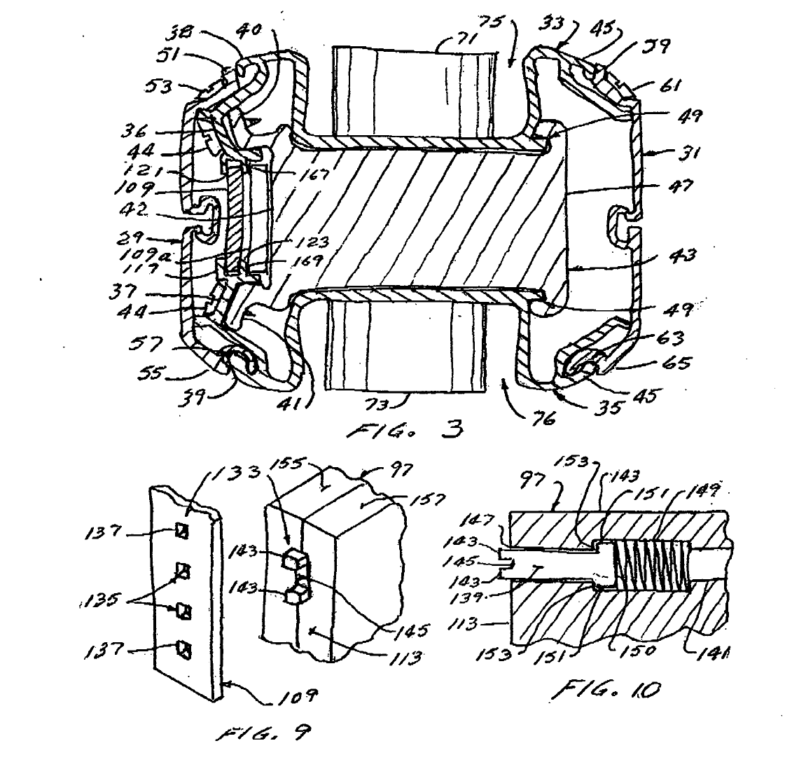

The lock structure 67 includes a bottom lock rod unit 95 below the locking unit 69 on the post as shown in FIGS. 2 and 7. The lock rod unit 95 includes a bottom moving block 97, as shown in FIG. 2, slidably mounted in the lower portion of the post 1 beneath the locking unit 69. The bottom moving block 97 carries a bottom lock rod 99 that extends down from the bottom end 101 of the moving block 97 to a position normally just at the bottom end 103 of the post 1. A fastener 105 locks the lock rod 99 in the bottom moving block 97 as shown in FIG. 7. The bottom lock rod 99 passes through, and is guided by a bottom spacer 43c fixed to the post 1 adjacent the bottom end 103 of the post. A compression spring 107 is mounted around the lock rod 99 between the bottom moving block 97 and the bottom spacer 43c to bias the bottom lock rod 99 upwardly to an unlocked position where the bottom end of the lock rod 99 is at the bottom end 103 of the post.

The bottom lock rod unit 95 has a rigid, connecting, bottom strap 109 that extends between the bottom moving block 97 and the locking unit 69 as shown in FIG. 2. The strap 109 extends up from the bottom moving block 97, adjacent the front wall 29 of the post 1, and passes in front of the front wall 93 of the locking unit 69 as shown in FIG. 4. The strap 109 extends a short distance above the latch 79 to terminate in a free end 111. The lower portion of the strap 109 passes by, and adjacent, the front 113 of the bottom moving block 97. The lower portion of the strap 109 is adjustably connected to the front 113 of the moving block 97 as will be described.

Guide members 117, 119 are provided for the strap 109. One guide member 117 is attached to the free end of the interior wall section 36 on the one side 38 of the one side wall 33 and the other guide member 119 is attached to the free end of the interior wall section 37 on the one side 39 of the other side wall 35. The guide member 117 is adjacent the end 42 of the spacer 43 and beside the short wall 40 on the spacer and the guide member 119 is adjacent the end 42 of the spacer 43 and beside the short wall 41. There is a slot 121 in the guide member 117 opening toward the guide member 119 and a similar slot 123 in the guide member 119 opening toward the guide member 117. The slots 121, 123 are just wide enough to receive the edge portions of the strap 109, and just far enough apart to receive the strap between them, the slots guiding the strap in its movement. The guide members 117, 119 extend the length of the post, formed integrally with the side walls 33, 35 of the post. The guide members could instead comprise short sections of slotted bars fixed to the front of the spacers 43a, 43b. Alternatively, longer sections of slotted bars could be fastened to the front of the locking unit 69. The sections however are not effective as the full length members.

The bottom moving block 97 can be moved within the locking post 1 from outside the post to move the lock rod 99 into the hole 21 in the floor 23. As shown in FIGS. 7 and 8, the moving block 97 has a handle 125 on the outside of each side wall 33, 35 of the post, each handle 125 connected to a respective side of the block 97 by a short post 127 passing through a longitudinal slot 129 in each side wall 33, 35.

An adjustable connection 133, as shown in FIGS. 9 and 10, connects the lower portion of the strap 109 to the front 113 of the moving block 97. The connection 133 includes a set 135 of spaced-apart openings 137 through the strap 109 in the area of the strap on or near the moving block 97. The openings 137 are preferably square in cross-section and can be spaced-apart between one quarter and one half an inch.

The adjustable connection 133 also includes a connecting member 139 slidably mounted in a cavity 141 formed in the moving block 97, preferably near its upper end 143. The connecting member 139 is movable toward and away from the front 113 of the moving block 97. The member 139 has at least one, and preferably two, pin connectors 143 at its front end 145 projecting out of an opening 147 of the cavity 141 in the front 113 of the block. A spring 149 in the cavity 141 at the rear end 150 of the connecting member 139 biases the member 139 toward the front 113 of the block 97. The connecting member 139 has top and bottom tabs 151 at its rear end 150 extending up and down from the connecting member 139. The tabs 151 cooperate with stop surfaces 153 formed in the top and bottom of the cavity 141 to limit the forward movement of the connecting member 139 out of the cavity so that only the connectors 143 project from the front 113 of the moving block 97. If two connectors 143 are used, as shown, they are spaced the same distance apart as adjacent openings 137 in the strap 109 are spaced apart. The connection can be made with one connector 143. The block 97 is preferably made in two parts 155, 157, which can be bolted together, to facilitate mounting of the connecting member 139 within the block.

The post 1 can be locked using only the lock structure 67 with a bottom lock rod unit 95. The lock structure 67 preferably however has a top lock rod unit 95a similar to the bottom lock rod unit 95. As shown in FIG. 2, the top lock rod unit 95a has a top moving block 97a slidably mounted in the post and spaced above the locking unit 69. The top moving block 97a carries a top lock rod 99a that extends up from the top moving block 97a to a position normally just at the top end 161 of the post. The top lock rod 99a passes through a top spacer 43d fixed to the post adjacent the top end 161 of the post. The top lock rod 99a will be offset laterally from the center of the post so as not to interfere with the trolley 163 carried by the post 1. Another spacer 41e could be used below the top moving block 97a to make the post more rigid if needed. The top lock rod 99a would pass freely through the spacer 43e. A top strap 109a is connected to the lower end of the top moving block 97a. The lower end portion of the strap 109a will pass the latch 79 in the locking unit 69 with its free end 111a below the latch 79 and will overlie the upper end of the bottom strap 109 as shown in FIG. 4. The top lock rod unit 95a has the same adjustable connection 133a between the strap 109a and the moving block 97a to adjust the length of the lock rod unit 95a as the adjustable connection 133 between strap 109 and block 97.

If a top lock unit 95a is deployed, the strap 109a will be guided between the ends 42 of the spacers 41 and the inner sides 167, 169 of the slots 121, 123 in the guide members 117, 119 carried by the side walls 33, 35. Strap 109 will overlie strap 109a in the vicinity of the latch 79 in the unlocked position of the lock units.

If only a bottom lock rod 99 is employed in the post, movement of the bottom moving block 97 downwardly, against spring 107, by one of the handles 125 that the moving block 97 carries outside the post, will move the bottom lock rod 99 out of the post and into a hole 21 in the floor 23 locking the closure to the floor. At the same time the strap 109 will be lowered and the free end 111 of the strap will move just below the latch 79. As the strap 109 is moved down past the latch, the latch 79 will be moved out to a locked position by its spring 87 to and will prevent the strap 109 from moving up when the handle 125 is released and thus retain the bottom lock rod 99 in the locked position. When the latch 79 is moved against its spring 87 to an unlocked position by a cylinder lock, the latch moves clear of the strap 109. The spring 99 will move the bottom lock rod unit 95 up moving the strap 109 past the latch 79 to an unlocked position while lifting the lock rod 99 up into the post to unlock the closure from the floor.

If the closure also employs a top locking unit 95a, the top lock block 97a is moved up first. As the top lock block moves up it moves the strap 109a up past the latch 79 allowing the latch to move out under the bottom edge 111a of the strap and against the bottom strap 99 and to retain the top lock rod 99 in the raised locked position. The bottom lock rod 99 can then be moved to a locked position as before. Unlocking the latch 79 will allow the bottom lock rod 99 to move up to its unlocked position, and continued movement of the latch to its unlocking position will allow top lock rod 99a to move down to its unlocked position under its own weight. A stop member 171 is formed in the strap 109a by cutting and bending a small section of strap so it abuts the fixed spacer 43a when the top lock unit moves down. If the unit is too light to move down when unlocked, a spring (not shown) can be employed around the lock rod 99a between the top of the top moving block 95a and the intermediate spacer 43e if one is employed or between the top moving block 95a and the top spacer 43d if spacer 43e is not employed. It is to be noted that if top and bottom locking units are employed, the bottom strap will be guided along a line closer to the front wall 29 than the line the strap 109a is guided along. The bottom strap 109 will therefore be connected to the bottom moving block 95 with slightly longer connecting pins 143 to keep the bottom strap on its line.

On floors that are uneven such as where there is a depression where the opening 21 in the floor 23 is located, and the lock rod 99 does not extend far enough in the opening 21 to secure the closure, the bottom lock rod unit 95 can be lengthened. The lengthening is accomplished using the adjustable connection 133 between the strap 109 and the moving block 97. The front wall 29 can be removed and the pins 143 in the adjustable connection 133 are pushed back out of the strap 79 and into the cavity 101 against spring 149. The strap 109 is then raised the required distance relative to the block 97 to lengthen the lock rod unit 35, and the connector pins 143 are replaced in different holes 137 in the strap to reconnect the strap 109 with the moving block 97. The raising of the strap 109 allows more of the lock rod 99 to extend from the post, as the moving block 95 is pushed down, to ensure secure locking when inserted into the opening 19. The free end 111 of the strap 109 has longer to travel to pass the latch 45 allowing more of the lock rod 67 to project from the post before reaching a locking position.

The guide members 117, 119 for the strap have been formed integrally in the interior wall sections of the side walls of the post. Guide members for the straps could instead be provided by mounting sections of guide members, similar to the guide members 117, 119, on the inner wall of the locking unit 69 or on the ends 42 of the spacers 43a, 43b.

The above description is meant to be exemplary only, and one skilled in the art will recognize that changes may be made to the embodiments described without departing from the scope of the invention disclosed. Modifications which fall within the scope of the present invention will be apparent to those skilled in the art, in light of a review of this disclosure, such modifications are intended to fall within the appended claims.

I claim:

1. A locking post for a folding closure having: a locking unit fixed within the post, the locking unit carrying a latch slidable across the post between an unlocked position and a locked position, a bottom lock rod unit slidable in the lower part of the post between an unlocked position within the post and a locked position where the unit projects from the bottom end of the post to lock the post, the lock rod unit in its unlocked position extending up past the latch with the latch in its unlocked position; a handle outside the post connected to the lock rod unit, the handle used to move the lock rod unit down to its locked position allowing the latch to move to its locked position to retain the lock rod unit in its locked position.

2. A locking post as claimed in claim 1 wherein the lock rod unit has a moving block slidable within the post, a lock rod extending from the bottom of the block and a rigid strap extending up from the top of the block, and an adjustable connection connecting the strap to the block to allow the length of the lock rod unit to be adjusted.

3. A locking post as claimed in claim 2 including a latch spring biasing the latch to its locked position and a lock rod unit spring biasing the lock rod unit to the unlocked position with the unit extending up past the latch to prevent the latch from moving to its locked position.

4. A locking post as claimed in claim 2 the wherein the adjustable connection comprises a set of spaced-apart openings extending longitudinally in the strap and at least one connecting pin in the moving block spring biased to project from the front of the block and insertable into one of the openings in the strap to detachably connect the strap to the block.

5. A locking post as claimed in claim 3 the wherein the adjustable connection comprises a set of spaced-apart openings extending longitudinally in the strap and at least one connecting pin in the moving block spring biased to project from the front of the block and insertable into one of the openings in the strap to connect the strap to the block.

6. A locking post as claimed in claim 2 including a pair of opposed guide slots within the post and located adjacent the front of the locking unit, the slots guiding the strap by its edges with the strap flat to and parallel to the front of the locking unit.

7. A locking post as claimed in claim 4 including a pair of opposed guide slots within the post and located adjacent the front of the locking unit, the slots guiding the strap by its edges with the strap flat to and parallel to the front of the locking unit.

8. A locking post as claimed in claim 2 wherein the post has a pair of side walls, the side walls each connected to a plurality of spaced apart spacers sandwiched between the side walls, each side wall having an interior wall section extending from one side of the side wall toward the one side of the other side wall, the free end of each interior wall having a guide slot facing the guide slot on the other interior wall, the guide slots receiving the edges of the strap.

9. A locking post as claimed in claim 4 wherein the post has a pair of side walls, the side walls each connected to a plurality of spaced apart spacers sandwiched between the side walls, each side wall having an interior wall section extending from one side of the side wall toward the one side of the other side wall, the free end of each interior wall having a guide slot facing the guide slot on the other interior wall, the guide slots receiving the edges of the strap.

11. A locking post for a closure having a locking unit in the middle of the post; a bottom lock rod unit slidably mounted in the bottom end of the post, the lock rod unit having a moving block, a lock rod extending from the bottom end of the moving block toward the bottom end of the post, and a rigid strap extending from the top end of the moving block to the locking unit and past a latch on the locking unit; the lock rod unit movable within the post to move the lock rod from the unlocked position within the post out of the bottom end of the post to a locked position; the latch on the locking unit movable transversely of the post to a locked position in the path of movement of the strap to prevent the strap from returning to is unlocked position.

12. A locking post as claimed in claim 11 including an adjustable connection to connect the strap to its moving block in a manner to be able to adjust the length of the lock rod unit.

13. A locking post as claimed in claim 12 wherein the adjustable connection comprises a set of equally spaced apart holes in a section of the strap at the top end of the moving block, the strap parallel to the front of the moving block, and at least one connector pin in the front of the moving block, spring biased from the block and movable through a selected hole in the set of holes in the strap to connect the strap and block together to obtain the desired length of the lock rod unit.

14. A locking post as claimed in claim 11 including a pair of opposed guide slots within the post and located adjacent the front of the locking unit, the slots guiding the strap by its edges with the strap flat to and parallel to the front of the locking unit.

15. A locking post as claimed in claim 11 wherein the post has a pair of side walls, the side walls each connected to a plurality of spaced apart spacers sandwiched between the side walls, each side wall having an interior wall section extending from one side of the side wall toward the one side of the other side wall, the free end of each interior wall having a guide slot facing the guide slot on the other interior wall, the guide slots receiving the edges of the strap.

16. A locking post for a folding closure having a locking unit in the post; the locking unit having a latch movable across the post between an unlocked position substantially within the locking unit and a locked position projecting prominently from the locking unit within the post; a bottom lock rod unit slidable in the lower part of the post between an unlocked position within the post where it extends up past the latch and a locked position where the unit projects from the bottom end of the post; a top lock rod unit slidable in the upper part of the post between an unlocked position within the post where it extends down past the latch and a locked position where the unit projects from the top end of the post, each lock rod unit having a moving block slidable in the post, the moving block having a lock rod extending from its end farthest from the locking unit and a rigid strap extending from its end closest to the locking unit, each strap extending past the latch and overlapping with the other strap in the unlocked position of the lock rod units, the lock rod units movable away from each other to move their straps back from the latch in moving to their locked position, the latch movable to its locked position as the straps move away from the latch; and an adjustable connection between the each strap and and its moving block to adjust the length of each lock rod unit.

17. A locking post as claimed in claim 16 the wherein the adjustable connection comprises a set of spaced-apart openings extending longitudinally in the strap and at least one connecting pin in the moving block spring biased to project from the front of the block and insertable into one of the openings in the strap to connect the strap to the block.

18. A locking post as claimed in claim 16 including a pair of opposed guide slots within the post and located adjacent the front of the locking unit, the slots guiding the strap by its edges with the strap flat to and parallel to the front of the locking unit.

19. A locking post as claimed in claim 16 including a lateral tab on the outer edge of the strap of the top lock rod unit that abuts one of the upper end of the locking unit or a spacer at the upper end of the locking unit to stop the top lock rod unit in its unlocked position when the upper end of the lock rod is even with the top of the post in moving to its unlocked position.
